(19) United States
(12) Patent Application Publication
(10) Pub. No.: US 2008/0071642 A1
(43) Pub. Date: Mar. 20, 2008

(54) SYSTEM AND METHOD FOR CONNECTING EXTERNAL PRODUCT CATALOG DATA TO BUSINESS APPLICATIONS

(76) Inventor: Lior LEIBA, Haifa (IL)

Correspondence Address: SAP_DLG, 7910 IVANHOE AVE., # 325, LA JOLLA, CA, 92037, US

(21) Appl. No.: 11/532,463

(22) Filed: Sep. 15, 2006

(51) Int. Cl. G06F 17/30

(52) U.S. Cl. 705/27

(57) ABSTRACT

A system and method for integrating external product catalog data. Employs a protocol that allows for external product catalog data to be integrated into server applications using HTTP via a browser. For example, when a user decides to purchase a product from an external product catalog, the system invokes an external catalog specified by a server and passes selected products from the external catalog to the server via the browser. The external catalog is completely independent from the server and is maintained by a third party. Allows for integration through a configuration phase that includes specifying mappings of the data attributes in external catalog to standardized mappings. This process does not require programming, for example coding software to use a database application programming interface to directly access data in an external catalog. Rather, the access to the catalog data is provided by a web-service interface to the product catalog.

### BACKGROUND OF THE INVENTION

1. Field of the Invention

Embodiments of the invention described herein pertain to the field of computer systems. More particularly, but not by way of limitation, one or more embodiments of the invention enable a system and method for integrating external product catalog data.

2. Description of the Related Art

Current on-line catalog systems are generally created to enable a user to browse a single website and purchase items from that website. There are no known systems that allow for the integration of an arbitrary number of specific product catalogs with another server that allows for seamless integration including product order functionality. For example, there are no known systems that allow for multiple catalogs to be queried for a type of product with the respective result sets displayed in a browser or portlet that allows for order completion to occur via a separate server regardless of the number of product catalogs involved.

In the realm of supplier relationship management, i.e., management of interactions with organizations that supply products and services to an enterprise, there are no known systems that provide this functionality. The goal of supplier relationship management is to streamline and optimize the business processes that exist between an enterprise and its suppliers. Since suppliers generally possess and maintain their own product catalogs, the integration of this product information is very difficult as the product catalogs contain proprietary schemas and attribute names. As the number of suppliers for an organization increases, the complexity involved with ordering the products and services required by an organization becomes staggering.

For at least the limitations described above there is a need for a system and method for integrating external product catalog data.

### BRIEF SUMMARY OF THE INVENTION

One or more embodiments of the invention enable a system and method for integrating external product catalog data. Embodiments of the invention utilize a protocol that allows for external product catalog data to be integrated into server applications e.g., using HTTP via a browser. For example, when a user decides to purchase a product from an external product catalog, the system invokes an external catalog specified by a server and passes selected products from the external catalog to a server via the browser. The external catalog is completely independent from the server and is maintained by a third party.

In one or more embodiments of the invention, an external catalog is integrated during a “configuration phase” that allows for use of the external catalog during a “run-time phase”. The configuration phase includes the mapping of data attributes in the external catalog to standardized mappings. This process does not require programming, for example coding software to use a database application programming interface to directly access data in an external catalog. Rather, a web-service interface to the product catalog may be utilized to access catalog data.

The run-time phase makes use of a viewer within a browser that is used to display products or other items from an external catalog. Embodiments of the invention may utilize a portlet as the viewer. Portlets are Java® based Web components that process requests and generate dynamic content in the form of markup, such as HTML, XHTML, and WML for example. Using a portlet based viewer allows for external product catalog data to be embedded into webpage in an existing website for example. The viewer embeds standardized server specific data in “hidden” HTML variables in one or more embodiments. The variables are used to inform the server of specific products selected for example when a user asserts an “Add to shopping cart” button associated with the external catalog.

Web-services may be utilized to wrap an external catalog to be integrated and provide catalog data and metadata. In one embodiment, a web-service skeleton is supplied to a developer that allows for easy modification of the web-service methods to allow integration. The web-service interface may provide search and render methods for example to search the external catalog and to display the results in the portlet.

In one or more embodiments, the configuration phase uses a wizard-based process to correlate the catalog data with the desired data to be displayed in the browser. The wizard allows for the configuration of catalog specific parameters, for example to allow the catalog specific parameters to be referred to in a standardized manner, e.g., “Prd_Desc” as used in the catalog may be standardized to “PRODUCT_NAME” for use in the server. The wizard-based configuration also allows for specific rules to be enforced in the mapping or configuration process. The outcome of the configuration process is a mapping file that relates catalog attributes with the standardized names.

An embodiment of a method for integrating external product catalog data includes: Obtaining an external catalog web-service URL from a server. Opening the URL of the external catalog web-service. Displaying a resulting search screen in a portlet viewing area. Obtaining a selection when a user selects one or more products and adds the products to a shopping cart. Sending the server the list of products from the viewer. The server may then implement other methods or interact with other systems to place an order. In addition, by utilizing background searching, the same search may be applied over multiple product catalogs simultaneously with the results displayed in the viewer. In this case, multiple product selections may yield multiple orders for items from different vendors.

One embodiment of the invention is implemented with an interface known as the “Open Catalog Interface” or “OCI”. The OCI allows for the display of external catalogs, extraction of details from the external catalogs when products are transferred to a user's shopping cart, display of customer specific views of an external catalog, recalculation of prices when quantities change in a shopping cart without requiring a user to delete a product and go through the product selection process again, and other functionality as described herein. The use of OCI is not required, yet is one particular implementation of a portion of an embodiment of the invention.

### BRIEF DESCRIPTION OF THE DRAWINGS

The above and other aspects, features and advantages of the invention will be more apparent from the following more particular description thereof, presented in conjunction with the following drawings wherein:

FIG. 1 is a simplified system view of an embodiment of the invention.

FIG. 2 is a system view of an embodiment of the invention.

FIG. 3 is a view of an embodiment of the configuration screen.

FIG. 4 is a view of an embodiment of the viewer.

FIG. 5 is a flowchart of an embodiment of the configuration phase.

FIG. 6 is a flowchart of an embodiment of the run-time phase.

FIG. 7 is a flowchart of an embodiment of the run-time phase utilizing additional functions.

### DETAILED DESCRIPTION

A system and method for integrating external product catalog data is described. In the following exemplary description numerous specific details are set forth to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art are not described in detail so as not to obscure the invention. Readers should note that although examples of the invention are set forth herein, the claims, and the full scope of any equivalents, are what define the metes and bounds of the invention.

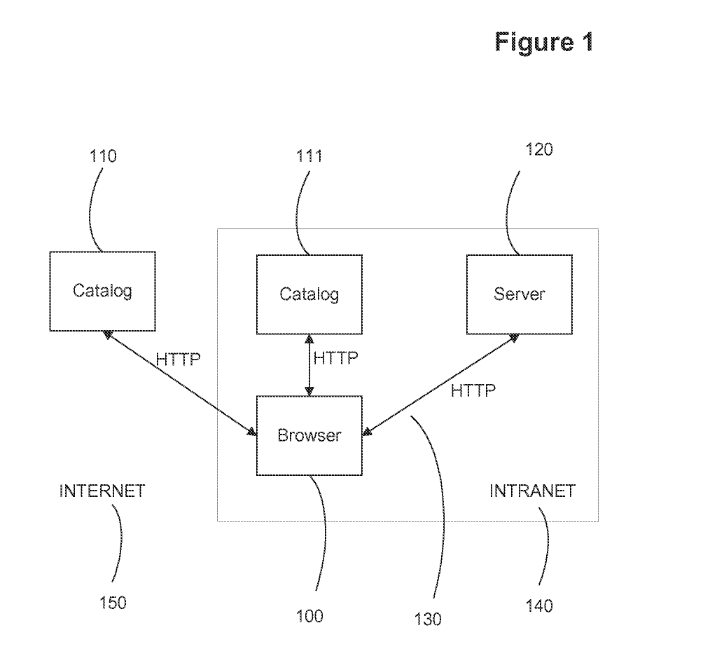

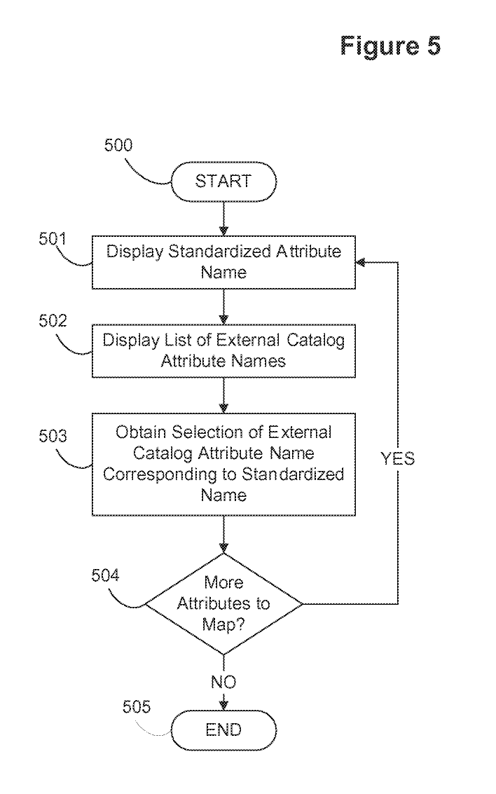

FIG. 1 is a simplified system view of an embodiment of the invention that enables integrating external product catalog data. Embodiments of the invention utilize a protocol that allows for external product catalog data as is found in web-based catalogs such as catalog 110 and catalog 111 to be integrated into server applications running on server 120 using a communications protocol such as HTTP 130 via browser 100. For example, when a user decides to purchase a product from an external product catalog, be it within intranet 140 or Internet 150, the system invokes the external catalog, here either catalog 110 or catalog 111 or both as specified by server 120 and passes selected products from the external catalog(s) to server 120 via browser 100. External catalogs 110 and 111 are independent from server 120 and are generally maintained by a third party. Utilizing an external catalog during the “run-time phase” is enabled by configuring the external catalog in the “configuration phase” as per FIGS. 5-7. Briefly, the configuration phase includes specifying mappings of the data attributes in an external catalog to standardized mappings. This process does not require programming, for example coding software to use a database application programming interface to directly access data in an external catalog. (In another embodiment of the invention, the configuration phase includes a wizard-based mapping that requires no coding and in addition, coding to access the external catalog inside the web-service skeleton). Rather, the access to the catalog data in catalog 110 or 111 is provided by a web-service interface to the product catalog as detailed below.

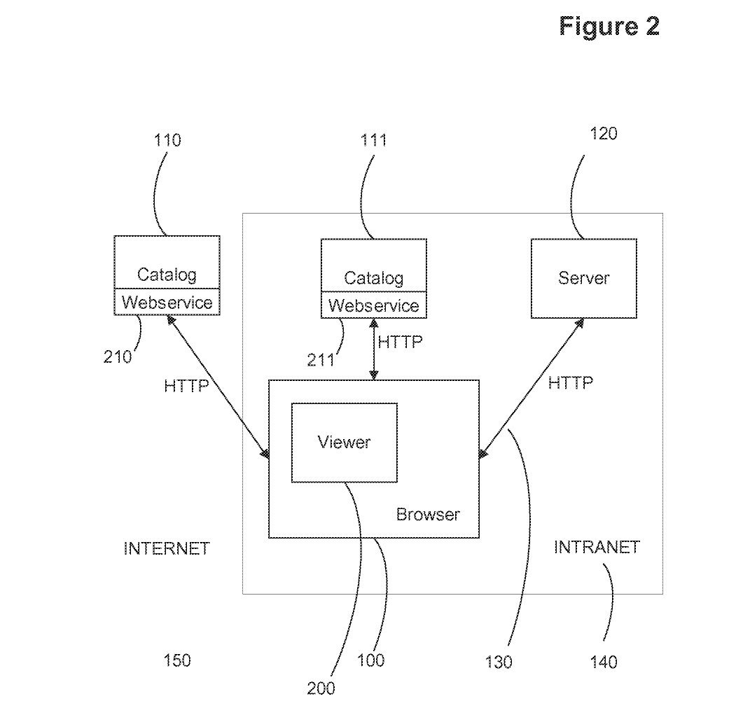

FIG. 2 is a system view of an embodiment of the invention. The run-time phase makes use of viewer 200 within browser 100 that is used to display products or other items from an external catalog. Embodiments of the invention may utilize a portlet as the viewer. Using a portlet as a viewer allows for external product catalog data to be embedded into an existing website for example. Web clients interact with portlets using a request/response methodology that is portlet dependent. For example, when a user clicks on a link or submits a form, the portlet processes the request and generates dynamic content. The content generated by a portlet is known as a fragment. Fragments can be aggregated to create a complete markup document. The viewer embeds standardized server specific data in “hidden” HTML variables in one or more embodiments. The variables are used to inform the server of the specific products selected for example when a user asserts an “Add to shopping cart” or “buy” button associated with the external catalog.

Web-services 210 and 211 may be utilized to wrap an external catalog to be integrated and provide catalog data and metadata. Tailoring web services to support a specific catalog may be performed by supplying a web service module to a catalog supplier and configuring the module without writing any software. Alternatively, a web-service skeleton may be supplied to a developer that allows for easy modification of the web-service methods to allow for integration. The web-service interface may provide a search and a render method for example.

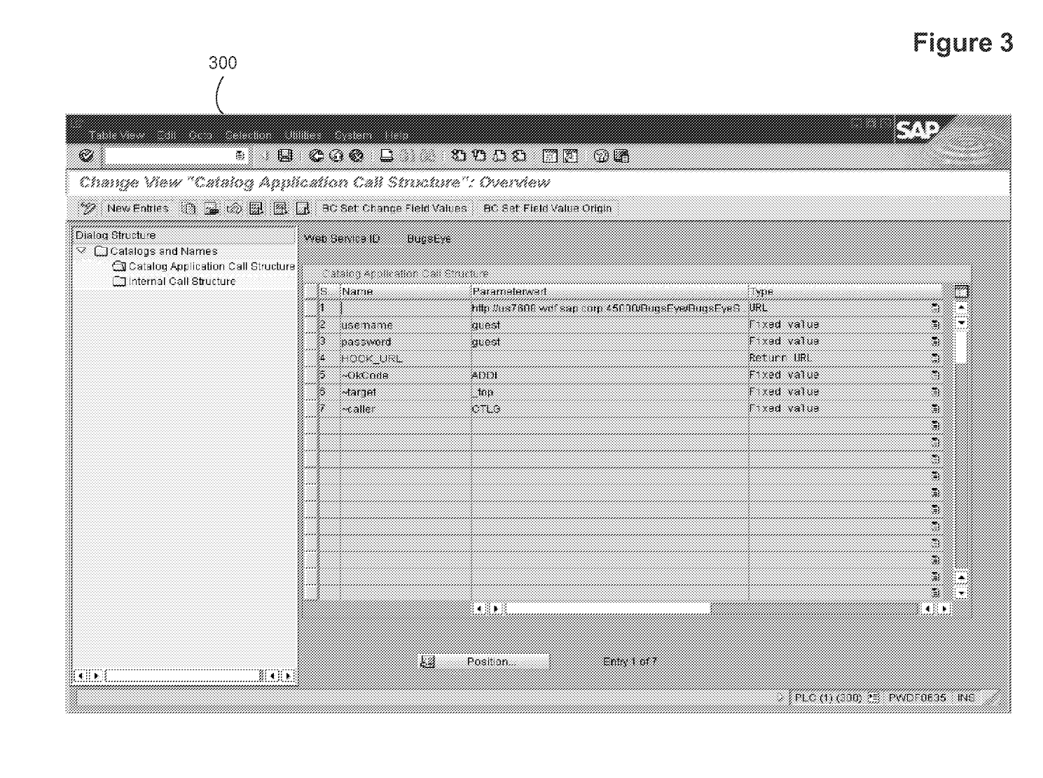

FIG. 3 is a view of an embodiment of the configuration screen. Configuration screen 300 for a particular catalog allows for the URL of the web-service associated with the catalog to be specified. In addition, any other parameters that are used in calling or working with the web-service may be specified with configuration screen 300. For example, setting up the call structure for catalog 110 (in FIG. 2) may involve setting a URL, username and password for use in interacting with web-service 210. This is shown as rows 1-3 in the center table of configuration screen 300. A catalog provider may specify particular parameters that are used in interacting with the provider's catalog. For example, setting a field value may involve setting a fixed value or a variable value. Setting a variable value may include a field such as “sy-langu”, for example the language in which to use in interacting with the catalog if the catalog supports multiple languages. Any variable used in the server or catalog may be specified in configuration screen 300. This flexibility allows for more sophisticated catalogs to be utilized without requiring software coding or software modifications. The return URL shown in row 4 of configuration screen 300 allows for the data from the catalog to be returned to the server via the browser to the specified URL. Generally, the return URL is specified in the construction of the Action attribute of the returned HTML form. Any parameters following the return URL are generated as parameters for the return URL. Any other parameters such as are shown in rows 5-7 of configuration screen 300 are placed in separate input fields of type “hidden” in the returned HTML form. The parameters shown in rows 5-7 are not transferred to the catalog web-service, but are used to provide information back to the server with the HTML form is asserted. Additional functions may be utilized that are catalog dependent.

In order to use additional functions, the additional functions are transferred as parameters to the external catalog at access time. The additional functions may be listed at the end of the parameter list, e.g., on and after row 8 of configuration screen 300 in this example. Additional functions may include “DETAIL”, which allows for product detail information to be made available for later use if the external catalog supports this function. The “DETAIL” function takes as a parameter the product identifier, i.e., the database key of the product in the external catalog. The product detail may be shown in the viewer and not transferred to the server, or in other embodiments of the invention, may be transferred to the server. In either case, the detail view of the product data is transferred at least to the browser.

Another example of an additional function is the “VALIDATE” function, this function takes two parameters, the product identifier and the quantity to purchase. The quantity is transferred so as to provide a variable scale depending on the quantity of product to be purchased. The resulting HTML arriving at the portlet may send the resulting data to the server via JavaScript® for example. Another example of an additional function is “BACKGROUND_SEARCH” which takes a search string as a parameter. The “BACKGROUND_SEARCH” function allows for a list of external catalogs to be searched simultaneously so that the user does not have to search a list of external catalogs with the same query one-by-one. Any other order for specifying and transmitting the parameters to the external catalog other than shown in configuration screen 300 is in keeping with the spirit of the invention.

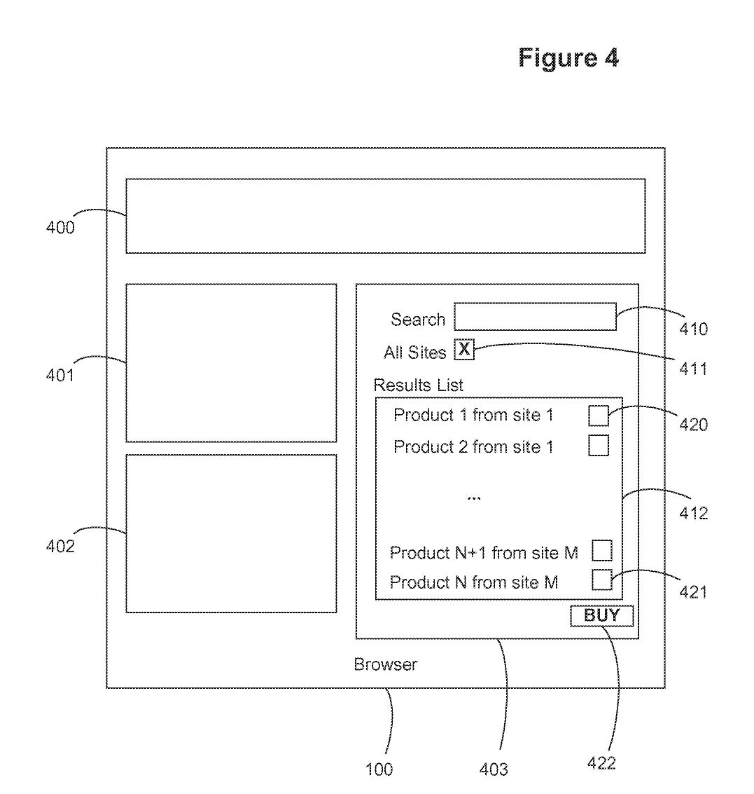

FIG. 4 is a view of an embodiment of the viewer. The response of the external catalog web-service to a query for example results in information displayed in a viewer in browser 100. Browser 100 contains separate areas such as banner 400, portlet 401, 402 and 403. Portlet 403 in this example depicts the viewer portlet. Viewer portlet 403 contains a search area 410 that accepts queries and is not limited to a single text field. Scope selector 411 accepts input into the scope of the search, here showing that all websites known to the portlet are to be searched using the query obtained from search area 410. Scope selector 411 may be implemented with a button as shown or with a multi-selectable list or any other type of graphical user input widget capable of signifying one or more websites in which to search. Results list 412 displays the results of the query and in this example shows products found in multiple external catalogs. Results list also shows selection buttons 420 and 421 that allow for products shown in the result list to be selected and purchased using buy button 422. Optionally, quantity fields may be associated with each product shown in results list 412. Any other input or graphical user interface type for selecting and quantifying or in any other way controlling the purchase of a product is in keeping with the spirit of the invention. For example, any other search widgets/buttons may be implemented freely as the web-designer/developer wishes.

The field names of returned products in the HTML form in one embodiment of the invention are as follows:

TABLE 1

| FIELD NAME | LENGTH | DESCRIPTION |
|---|---|---|
| DESCRIPTION[n] | 40 | Description of the product |
| MATNR[n] | 40 | Product number known to |
| | | server |
| QUANTITY[n] | 15 | Product quantity |
| UNIT[n] | 3 | Units for ‘product quantity’ |
| PRICE[n] | 15 | Price of product per unit |
| CURRENCY[n] | 5 | Item currency |
| LEADTIME[n] | 5 | Delivery time in days |
| VENDOR[n] | 10 | Vendor number known to |
| | | server |
| VENDORMAT[n] | 40 | Product number known |
| | | to vendor |
| MANUFACTMAT[n] | 40 | Product's manufacturer |
| | | part number |
| CONTRACT[n] | 10 | Contract to which product |
| | | refers as per server |
| EXT_PRODUCT_ID[n] | 40 | Database key for product in |
| | | external catalog |
| ITEM_CUST_FIELD1[n] | 10 | User defined field 1 |
| . . . | . . . | . . . |
| ITEM_CUST_FIELDM[n] | 10 | User defined field M |

Each occurrence of “[n]” in the above table is filled with the index of the actual returned product from 0 to N-1 for example. Other fields such as product long text description, material group, attachment and category may be utilized. Any other field that may be associated with a product may also be sent be in the HTML form data. There are four fields that describe product numbers, MATNR[n] describes the product number as known on the server, i.e., the purchaser's version of the product number. VENDORMAT[n] describes the product number known to the vendor. MANUFACTMAT[n] describes the product number known to the manufacturer of the product. EXT_PRODUCT_ID[n] uniquely describes the product in the catalog, i.e., the database key for the product.

Configurable products may be handled by selecting various options associated with each product as passed into the viewer. The selected options are then sent to the server when the user decides to purchase the product. Any method of transferring an option/setting pair is in keeping with the spirit of the invention.

The configuration phase makes use of a wizard-based process to correlate the catalog data through the web-service with the desired data to be displayed in the browser. The wizard allows for the configuration of catalog specific parameters, for example to allow the catalog specific parameters to be referred to in a standardized manner, e.g., “Prd_Desc” as used in the catalog may be standardized to “PRODUCT_NAME” for use in the server. The wizard-based configuration also allows for specific rules to be enforced in the mapping or configuration process. The outcome of the configuration process is a mapping file that relates catalog specific attributes with the standardized names as shown in table 1.

FIG. 5 is a flowchart of an embodiment of the configuration phase. Processing begins at 500. A standardized name as shown in table 1 is displayed at 501. A list of the external catalog attribute names is displayed at 502. The list may be in any form and may be alphabetized for example or grouped by importance, size or any other method. The system obtains a selection corresponding of the external catalog attribute name corresponding to the standardized name at 503. If there are more standardized attributes to correlate/map as determined at 504, then another standardized attribute is displayed at 501 and the process continues. If there are no further standardized attributes to map, then the process completes at 505. Mapping an external catalog attribute name such as “Prd_Desc” to a standardized name utilized in an embodiment of the invention such as “PRODUCT_NAME” allows for uniform processing of data from a plurality of external catalogs.

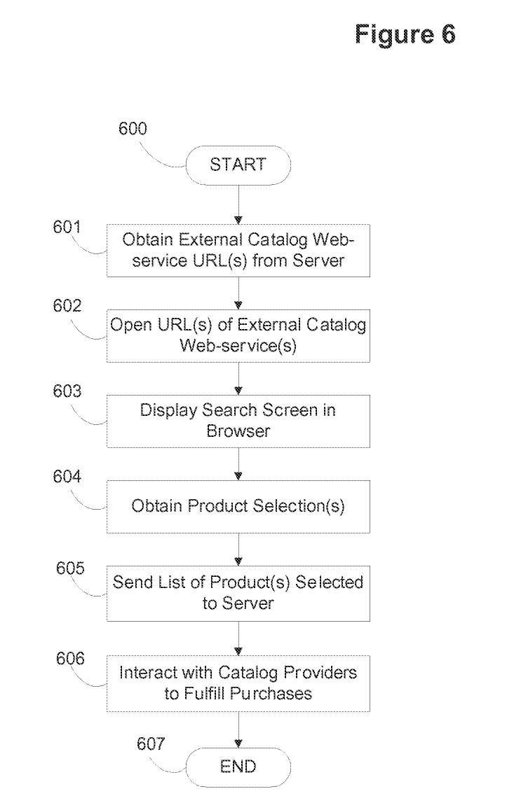

FIG. 6 is a flowchart of an embodiment of the run-time phase. Processing starts at 600. One or more external catalog web-service URLs is/are obtained from a server at 601. The URL(s) of the external catalog web-service(s) are opened at 602. Embodiments of the invention allow for a single query for example to execute over multiple external catalogs. The search screen is displayed in the viewer in the browser at 603 along with any results from a previous search. Embodiments of the invention may utilize any type of markup, e.g., HTML, XHTML or WML and may thus execute on any computing element of any type capable of displaying that type of markup. Optionally, the catalog web-service may be provided with a browser and platform parameter that determines the type of markup produced for the given computing element. The product selection(s) are obtained at 604 when a user selects one or more products and adds the products to the shopping cart or decides to buy them via the viewer for example. The list of products is sent from the viewer to the server at 605. The server may then implement other methods or interact with other systems to place and/or fulfill an order at 606. Processing ends at 607.

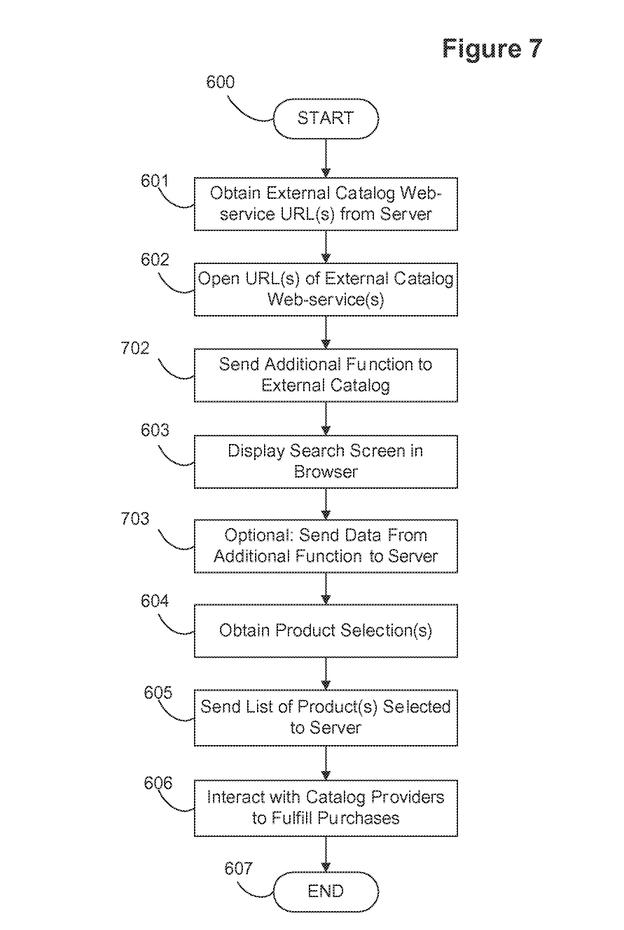

FIG. 7 is a flowchart of an embodiment of the run-time phase utilizing additional functions. Processing starts at 600. One or more external catalog web-service URLs is/are obtained from a server at 601. The URL(s) of the external catalog web-service(s) are opened at 602. Any additional function desired is sent to the external catalog web-service as a parameter at 702. This may include any of the additional functions listed above such as “VALIDATE” for example. The search screen is displayed in the viewer in the browser at 603 along with any results from a previous search. Optionally, any data derived from the execution of the additional function may be sent to the server at 703. Alternatively, the data may be held in the viewer for use solely in the browser. The product selection(s) are obtained at 604 when a user selects one or more products and adds the products to the shopping cart or decides to buy them via the viewer for example. The list of products is sent from the viewer to the server at 605. The server may then implement other methods or interact with other systems to place and/or fulfill an order at 606. Processing ends at 607.

An embodiment of the web-service interfaces configured to wrap an external catalog for integration purposes is as follows wherein OCI represents the “Open Catalog Interface” of embodiment of the invention detailed herein:

Interface Definition

Public Resultset Products Search (Query q)

Input Parameters:
Query—an object that encapsulates the query to the catalog, in the form of a list of {variable≧=≦value}. The relation between the tuples is a logical AND.
e.g., {Name=‘Karl’ } AND {price>=100}

Return Value:
Resultset—the list of products, i.e., the answer to the query. Each product is a list of {attribute, value, type} tuples.
e.g., {FirstName, ‘Karl’, string}, {LastName, ‘May’, string}, . . .

Description

The functionality of this web-service is the basic search functionality of the external catalog. A web-service, implementing this interface, is exposed by each catalog provider to allow for integration. Some catalog providers may already possess a search web-service, and in this case the only work that is left is to “wrap” it in the Search interface above.

Public ResultsHTML string RenderResults (Resultset CatalogProducts)

Input Parameters:
CatalogProducts—the result set (structure as described above) returned from the catalog after attribute name have been mapped (see OCIMap method below).

Return Value:
ResultsHTML—a string representing the HTML string to be displayed. It includes both the HTML representing the results set (a table) and the hidden variables (as previously described).

Description

This method performs two operations:
a) It renders the result-set (the products list) into HTML format
b) Seamlessly, embeds the HTML hidden variables, in standardized format, in the result HTML.

Private Resultset MapAttributes OCIResult (Resultset CatalogResult)

Input Parameters:
CatalogReuslt—the Resultset structure as described above. This is the products list chosen by the user (as candidates for buying) with the naming of the catalog

Return Value:
OCIResult—the result set structure is as described above. This is the result set with naming as previously described after the mapping. This is the result set that is later rendered to the hidden variables.

Description

This method goes over the products list as it returned from the catalog. This method uses the names mapping as created in the configuration phase) to change the catalog attribute names to their corresponding standardized name.

Embodiments of the webservice described herein may be extended to support VALIDATE and DETAILS functions or any other functionality as described and that all embodiments described herein are exemplary only. While the invention herein disclosed has been described by means of specific embodiments and applications thereof, numerous modifications and variations could be made thereto by those skilled in the art without departing from the scope of the invention set forth in the claims.

What is claimed is:

1. A computer program product comprising computer readable instruction code executing in a tangible memory medium of a computer for connecting external product catalog data to business applications wherein said computer readable instruction code configured to:
obtain at least one external catalog web-service URL from a server;
open said at least one external catalog web-service URL;
display a search screen in a viewer in a browser;
obtain at least one product selection from at least one external catalog; and,
send said at least one product selection from said at least one external catalog to said server.

2. The computer program product of claim 1 wherein said computer readable instruction code is further configured to:
interact with at least one external catalog provider to fulfill at least one purchase.

3. The computer program product of claim 1 wherein said computer readable instruction code is further configured to:
send an additional function to said at least one external catalog web-service URL from said viewer.

4. The computer program product of claim 1 wherein said computer readable instruction code is further configured to:
send data obtained from an additional function execution at said at least one external catalog web-service URL to said server.

5. The computer program product of claim 1 wherein said computer readable instruction code is further configured to:
send an additional function to said at least one external catalog web-service URL from said viewer; and,
send data obtained from an additional function execution at said at least one external catalog web-service URL to said server.

6. The computer program product of claim 1 wherein said computer readable instruction code is further configured to:
communicate over HTTP to obtain said at least one external catalog web-service URL;
communicate over HTTP to open said at least one external catalog web-service URL;
communicate over HTTP to send said at least one product selection from said at least one external catalog to said server.

7. The computer program product of claim 1 wherein said computer readable instruction code is further configured to:
display a standardized attribute name in said browser;
display a list of external catalog attribute names in said browser;
obtain a selection of an external catalog attribute name selected from said list of external catalog attributes names that corresponds to said standardized attribute name; and,
determine whether map more standardized attributes.

8. A system for connecting external product catalog data to business applications comprising:
a browser;
a viewer displayed in said browser;
at least one external catalog;
at least one external catalog web-service associated with said at least one external catalog wherein each of said at least one external catalog web-service has an associated at least one external catalog web-service URL;
a server;
said viewer configured to:
obtain said at least one external catalog web-service URL from said server;
open said at least one external catalog web-service URL;
display a search screen in said viewer in said browser;
obtain at least one product selection from said at least one external catalog; and,
send said at least one product selection from said at least one external catalog to said server.

9. The system of claim 8 wherein said server is configured to interact with at least one external catalog provider to fulfill at least one purchase.

10. The system of claim 8 wherein said viewer is further configured to send an additional function to said at least one external catalog web-service URL.

11. The system of claim 8 wherein said viewer is further configured to send data obtained from an additional function execution at said at least one external catalog web-service URL to said server.

12. The system of claim 8 wherein said viewer is further configured to send an additional function to said at least one external catalog web-service URL and send data obtained from an additional function execution at said at least one external catalog web-service URL to said server.

13. The system of claim 8 wherein said viewer is further configured to communicate over HTTP to obtain said at least one external catalog web-service URL and communicate over HTTP to open said at least one external catalog web-service URL and to communicate over HTTP to send said at least one product selection from said at least one external catalog to said server.

14. A system for connecting external product catalog data to business applications comprising:
means for obtaining at least one external catalog web-service URL from a server;
means for opening said at least one external catalog web-service URL;
means for displaying a search screen in a viewer in a browser;
means for obtaining at least one product selection from at least one external catalog; and,
means for sending said at least one product selection from said at least one external catalog to said server.

15. The system of claim 14 further comprising:
means for interacting with at least one external catalog provider to fulfill at least one purchase.

16. The system of claim 14 further comprising:
means for sending an additional function to said at least one external catalog web-service URL from said viewer.

17. The system of claim 14 further comprising:
means for sending data obtained from an additional function execution at said at least one external catalog web-service URL to said server.

18. The system of claim 14 further comprising:
means for sending an additional function to said at least one external catalog web-service URL from said viewer; and,
means for sending data obtained from an additional function execution at said at least one external catalog web-service URL to said server.

19. The system of claim 14 further comprising:
means for communicating over HTTP for said obtaining said at least one external catalog web-service URL;
means for communicating over HTTP for said opening said at least one external catalog web-service URL;
means for communicating over HTTP for said sending said at least one product selection from said at least one external catalog to said server.

20. The system of claim 14 further comprising:
means for displaying a standardized attribute name in said browser;
means for displaying a list of external catalog attribute names in said browser;
means for obtaining a selection of an external catalog attribute name selected from said list of external catalog attributes names that corresponds to said standardized attribute name; and,
means for determining whether map more standardized attributes.
